(19) United States
(12) Patent Application Publication
(10) Pub. No.: US 2026/0249643 A1
(43) Pub. Date: Aug. 27, 2026

(54) WHEEL COMPONENT FOR A BICYCLE

(71) Applicant: DT SWISS INC., Grand Junction, CO (US)

(72) Inventor: Andreas HENIG, Biel (CH)

(21) Appl. No.: 19/543,173

(22) Filed: Feb. 18, 2026

(30) Foreign Application Priority Data
Feb. 25, 2025 (DE) 10 2025 107 081.4

(51) Int. Cl. B60B 1/04

(52) U.S. Cl. CPC B60B 1/044

(57) ABSTRACT

A bicycle wheel component includes a spoke system having a spoke, and a spoke nipple, the spoke extends axially and includes a center piece and two end pieces to connect the spoke to a hub and to a rim by the end pieces. The spoke is a fiber composite material and includes a matrix material and embedded reinforcing elements. The spoke nipple and an end piece of the spoke have interacting threads to connect to one another. The threads are an inner thread and an outer thread. The threads are designed as non-symmetrical in the axial direction, so that one thread flank is shallower than the other, steeper thread flank. The end pieces are integral with the center piece and form a spoke end. At least some of the reinforcing elements are long fibers and extend in a cross-sectional area completely through the center piece and through the end pieces.

The present invention relates to a wheel component for a vehicle, and in particular for a two-wheel or multi-wheeled vehicle, like a bicycle, that is at least partially muscle-powered in the intended normal or regular operation, and comprises a spoke system having two interacting connecting elements or spoke units, namely having a connecting element designed as a spoke and having a connecting element designed as a spoke nipple. A spoke of the spoke system comprises a center piece and two end pieces in order to detachably connect the spoke to a hub of a wheel or to a rim of a wheel. The spoke may be manufactured from a fiber composite material and comprises a matrix material and reinforcing elements embedded therein.

Wheels for bicycles made of fiber composite material, in which the spokes are produced directly with the rim, have become known. Such wheels may have a low weight, but they are complicated to produce and difficult to maintain. The entire wheel has to be replaced regularly, even in the case of minor defects, which is not very sustainable. Or the wheel must be laboriously repaired.

A separate spoke made from fiber composite material, produced through an injection molding process, was made known from U.S. Pat. No. 5,350,221. Short-fiber fiber composite material is thereby injected into a cavity of a production mold so that the fiber material is homogeneously distributed in the cavity of the mold. At the one end, the spoke has an angled head and, at the other end, a thread for screwing to a spoke nipple. Such a spoke has not established itself on the market over the last decades. In the same document, a spoke is also described, on which metallic ends are used so that the force dissipating points on the spoke are manufactured from metal.

US 2024/0051333 A1 discloses a spoke made from fiber composite material, wherein initially a central and elongate spoke body is produced by an injection method and has a corrugated structure on the surfaces of the respective ends. A connecting segment with an adapted, corrugated, inner structure is applied onto the corrugated structure. The corrugated structures provide a friction-increasing structure and improve the axial holding by the connecting segment and by the spoke body. By this means, a sliding of the connecting segment along the spoke body is to be prevented. Wider thread turns in the axial direction are formed by a sawtooth thread, which improves the transferability of axial tensile forces. It is questionable whether the spoke withstands higher loads.

A spoke made from a fiber composite material, in which the spoke body is produced by a pultrusion process, was made known by EP 3 459 759 B1. Stepped surfaces and angled areas are provided on the spoke body, made from fiber composite material, onto which angled areas the bushings are applied, which consist of stainless steel and establish the connection to the hub or to the rim. Such a spoke basically works; however, it is complicated to produce.

A reinforced fiber spoke for a bicycle is known from WO 03/020535A2, which has an elongate spoke body, on which bushings are applied before the ends of the spoke body are thickened, in order to thus hold the separate bushings on the spoke body. The bushing provided for fastening the spoke to the rim has a spherical seat in order to enable an alignment of the spoke. The bushing at the other end comprises an outer thread in order to screw the spoke to the hub using a corresponding thread. The spoke body is produced by pultrusion. This spoke is also functionally satisfactory and enables a light weight. However, the significant production costs are disadvantageous.

It is therefore the object of the present invention to provide a wheel component having a light-weight spoke system which is able to withstand high loads. In particular, the spoke system should be easy to produce and to assemble.

This problem is solved by a wheel component having the features of claim 1, and by a wheel component having the features of claim 16 or 17. Preferred refinements of the invention are the subject matter of the subclaims. Additional advantages and features of the present invention arise from the general description and the description of the exemplary embodiments.

A wheel component according to the invention for a vehicle and in particular for a bicycle comprises (at least) one spoke system having two interacting connecting elements (spoke units), namely a connecting element (loaded in tension during operation and) designed as a spoke and having at least one connecting element designed a spoke nipple. The spoke extends in the axial direction (and is, in particular, designed as straight and elongated) and has a center piece and two end pieces, in order to detachably connect the spoke to a hub (of a wheel) and to a rim (of the wheel) by means of the end pieces. The spoke is (at least partially and, in particular, completely) manufactured from a fiber composite material and comprises at least one matrix material and reinforcing elements embedded therein. The spoke nipple and at least one end piece of the spoke have interacting threads in order to connect the spoke and the spoke nipple to one another, wherein one of the threads is designed as an inner thread and one of the threads is designed as an outer thread. The interacting threads of the connecting elements are respectively designed as non-symmetrical in the axial direction, so that one respective thread flank is designed as significantly shallower (shallower thread flank) than the other (and steeper) thread flank (steeper thread flank). The end pieces are designed integrally with the center piece and respectively form an end of the spoke. At least some of the reinforcing elements are designed as long fibers and extend in a cross-sectional area completely (i.e., continuously or “endlessly”) through the center piece and respectively across at least a substantial part of both end pieces.

The wheel component according to the invention has many advantages. One significant advantage of the wheel component according to the invention consists in that the load capacity may be improved. The spoke system may transfer high tensile forces. Long fibers, which (respectively integrally) extend from one end to the other end of the spoke, contribute significantly to this. Long fibers are, in the sense of this application, continuous fibers.

Because an asymmetrical profile with different flank angles is present, high forces may be transferred along the spoke system in the axial direction.

It has surprisingly been found, that such an asymmetrical thread shape is not only suitable as a movement thread in the area of screw presses or hydraulic presses, but also particularly reliably satisfies the conditions for use in spoke systems. The design enables the transfer of high (tensile) forces in the axial direction to the shallower thread flank. A greater locking of the screw connection is thus able to be realized. In addition, it is not necessary to apply or introduce an adhesive. The use of a two-component adhesive is also not necessary in order to guarantee the connection security. As no glue or adhesive is used regularly, the spoke tension may be correctly adjusted (increased or decreased) as needed at any time, without affecting the stability or the reliability.

In particular, a light-weight and easily manufacturable wheel component is also provided, which is highly resilient.

The end pieces, designed integrally with the center piece, enable a high load capacity and prevent settling phenomena, which may occur in the case of multi-part spokes. This can negatively affect the spoke tension and the centering of a wheel. This is prevented in the case of the invention.

The spoke may be substantially produced by pultrusion, wherein the end pieces or parts thereof are then injection molded onto the center piece, while the matrix material of the center piece is still liquid, or after it has been made semi-liquid or liquid. An (in particular jointless and) integrally-formed wheel component thus results, for which no adhesions, glue layers, or separating boundary layers are present, even in the interior of the spoke. A material connection is created. It is conceivable that boundary layers, or rather boundary areas, are visible at the microscopic level. However, there is definitely no separate intermediate layer, like a glue layer, present. In a sectional view, a change from one material of the reinforcing elements and/or in the size and the size distribution of the reinforcing elements is visible. In simple cases, the fiber material and/or the fiber dimensions change, and preferably no boundary layer and/or no transition is visible in the matrix.

The spoke has, in particular, a spoke body, designed as straight and elongated, which comprises a center piece and two end pieces designed integrally therewith on its ends, located opposite and spaced apart from one another. The spoke is designed, in particular, as straight and has no bend.

The spoke body preferably has no through holes or depressions, at which other parts may be hooked in. The surface of the connecting elements is, with the exception of the threads, preferably designed as smooth and has no hooks or eyelets.

Long reinforcing fibers and, for example, continuous fibers, are used as long fibers in the connecting elements and are correspondingly cut to the length of the spoke, for example, after a or the pultrusion. Stated succinctly, in the context of this application, long reinforcing fibers are also called long fibers (or “continuous fibers”). “Continuous fibers”, because they were continuous in production and/or because they extend from one end of the spoke to the other end.

In one preferred embodiment, at least one end piece has a larger outer diameter than at least one transverse dimension in the center piece. In particular, at least one outer diameter of an end piece is larger than a minimum transverse dimension and/or an average transverse dimension and/or a maximum transverse dimension in the center piece.

A transverse dimension is thereby understood to mean a dimension aligned transversely or perpendicular to the longitudinal axis or to the axis of symmetry of the spoke. In simple embodiments, the transverse dimension may be the diameter in a central area of the center piece.

In one preferred embodiment, at least one end piece and, in particular at least one head portion, has a thickened portion (directly or also indirectly) adjacent to the center piece of the spoke and a support portion connecting in turn thereto. The thickened portion, manufactured integrally with the entire spoke body, ensures, together with the support portion, a reliable support for the spoke. In the thickened portion, at least one dimension of the spoke expands transversely to the longitudinal direction of the spoke. In all embodiments, the thickened portion may be configured like a cone. The thickened portion may then also be designated as a conical portion.

This thickened portion, or also conical portion, may also have a function of holding the spoke during wheel assembly, so that no damage occurs to the spoke due to twisting.

Preferably, at least one of the end pieces has a threaded portion (with the thread) for screwing to a spoke nipple. Preferably, at least one of the end pieces has a head portion for supporting the spoke. It is possible and particularly preferred that one of the end pieces comprises a head portion for supporting the spoke and the other end piece comprises threaded portion for screwing to a spoke nipple. However, it is also possible that head portions are designed at both ends. Or that threaded portions are designed at both ends.

It is also possible that a head portion with a threaded portion designed thereon is included at both ends. Then, e.g., a thickening may be included as the head portion on both ends, wherein a (cylindrical) threaded portion is designed on the head portion. This facilitates flexible usage.

In advantageous refinements, at least one end piece comprises a cross-sectional area with long fibers embedded therein as reinforcing elements, and at least one cross-sectional portion with shorter reinforcing elements embedded therein. The shorter reinforcing elements are thereby designed as shorter than the longer reinforcing elements or long fibers. The shorter reinforcing elements are particularly preferably shorter than ⅕ or 1/10 the length of the long fibers. The length of the long fibers corresponds, in particular approximately or substantially, to the spoke length or to the length of a spoke nipple and achieves or exceeds at least 90% or 95% or 99% of the length of the spoke or of the spoke nipple. Preferred variants of shorter reinforcing elements, which are designed as fibers, may also be designated as short fibers in the context of this application.

It is possible that the cross-sectional portion is designed as free of long fibers. It is preferred that the cross-sectional portion comprises a lower proportion of long fibers than the cross-sectional area. It is particularly preferred that the central area of the center piece is a cross-sectional area with (exclusively) long fibers as reinforcing elements. Since the long fibers run, in principle, through the entire spoke, there are also long fibers at the ends (in the center or surrounding the same).

At least one part of the reinforcing elements is preferably formed by short fibers, which are designed as significantly shorter than the long fibers.

A cross-sectional area may also be designated as a long fiber area, and a cross-sectional portion may also be designated as a short fiber area. Short fibers are to be understood in the context of this application in particular as reinforcing fibers, which have a length between 0.1 mm or 0.2 mm and approximately 3 cm. Short fibers shorter than 10 mm are particularly preferred.

It is preferred that a significant part of the cross-sectional area has exclusively long fibers as reinforcing elements.

It is also possible and preferred in all embodiments, that a significant part of the cross-sectional portion (or the whole cross-sectional portion) has no reinforcing elements or only exclusively shorter reinforcing elements (for example, in the form of short fibers or other reinforcing elements).

In preferred embodiments, at least one part of the shorter reinforcing elements is formed by fiber snippets and/or reinforcing particles. Fiber snippets are, in particular, flat elements. Reinforcing particles may be spherical elements, powder particles, or also irregular particles.

It is also possible that the cross-sectional portion has no or only a small amount of reinforcing elements, so that a proportion by weight of reinforcing elements in the cross-sectional portion is much lower than a proportion by weight of reinforcing elements in the cross-sectional area. A lower amount of shorter reinforcing elements may be contained in the cross-sectional area. It is also possible that virtually none or absolutely no reinforcing elements are present in the cross-sectional area.

It is preferred that the shallower thread flank is respectively aligned in the tensile direction in the assembled state and forms a load-bearing flank (or the load-bearing flank of the thread). In particular, the shallower thread flank has an angle of less than 100 or less than 8° perpendicular to the longitudinal direction. The steeper thread flank has, in particular, an angle greater than 20° or 25° perpendicular to the longitudinal direction, and forms a non-load-bearing flank. The steeper thread flank has, in particular, an angle less than 60° or 50° perpendicular to the longitudinal direction. A flank angle between the thread flanks is preferably between 25° and 60°.

Unlike triangular, round, or trapezoidal threads, which all have a thread profile generally designed as symmetrical, the interacting threads (threaded portions) for the spoke system according to the invention are designed asymmetrically and the angles of the two thread flanks are not identical, but instead differ significantly.

Load-bearing and non-load-bearing flanks are thus provided, and two different values result for the flank angle, namely, respectively different angles between the thread flank and a line standing perpendicular to the axial direction. The flank angle of the sawtooth thread then arises from these two values. For example, a type of metric sawtooth thread may be used, in which the angle at the load-bearing thread flank is 3° and the angle at the non-load-bearing thread flank is 30°. The flank angle between the two thread flanks is then (approximately) 33°. This is along the lines of DIN 513-1 to DIN 513-3, where, however, larger diameters, from 10 mm to 640 mm, are defined, and not very small thread dimensions, as are used in this case.

It is also possible to configure the threads with reference to an American ANSI sawtooth thread. The angle of the non-load-bearing flank may then be 45° and 7° at the load-bearing flank.

Straight, one-sided loads may be dissipated well by such a structure. The load-bearing thread flank is approximately perpendicular to the axial direction and may thus dissipate the very high dynamic forces in spoke systems in the axial direction.

A thread, used in a spoke system according to the invention, may be designed, in particular, as a type of sawtooth thread. Or a thread in the spoke system is designed along the lines of such a thread. In the most well-known areas of application, sawtooth threads are generally first used stating at diameters of 10 mm. In contrast, spokes or spoke nipples generally have much smaller (transverse) dimensions or diameters.

In all embodiments, it is particularly preferred that a maximum thread diameter of an outer thread (of a spoke unit or of a connecting element) is less than 8 mm and preferable less than 5 mm. In particular, a minimum thread diameter of an inner thread is greater than 1 mm or greater than 1.5 mm or greater than 2 mm. The maximum thread diameter thereby corresponds, in particular, to the outer thread diameter and the minimum thread diameter of an inner thread corresponds to the clear inner diameter.

A thread pitch (of an inner and of an outer thread) between 0.3 mm and 0.9 mm is particularly preferred.

A difference in diameter from a maximum thread diameter to a minimum thread diameter (of the same thread) is preferably between 0.5 mm and 1.5 mm.

In all embodiments, it is possible and also preferred that the spoke nipple consists at least partially of (at least) one metal. The spoke nipple as a connecting element may also consist largely or virtually completely or completely of metal, for example, of a light metal.

The end pieces of the spoke are designed, in particular, integrally with the center piece and respectively form an end of the spoke. At least some of the reinforcing elements are designed, in particular, as long fibers and extend completely through the center piece and respectively across at least a substantial part of both end pieces of the spoke.

In particularly preferred embodiments, the cross-sectional portion comprises the same matrix material as the cross-sectional area. This means, in particular, that the identical or even the same matrix material is used in the short fiber area and in the long fiber area. This then means that the matrix material of the spoke is preferably uniform overall.

Thus, the same matrix material or the same material type of matrix material may be used in the entire spoke and in the entire spoke nipple. Preferably, at least one matrix material of the same type is used, which enters into a material connection. A boundary layer is particularly preferably not visible even in a micrograph. Where appropriate, it is also possible that slightly different matrix materials are used. It is particularly preferred that the basic components of the matrix material are identical.

It is particularly preferred that the material of the reinforcing elements of the spoke and/or of the spoke nipple is uniform overall. However, it is thereby possible and preferred that the material of the reinforcing elements in the cross-sectional portion differs at least partially from the material of the reinforcing elements in the cross-sectional area. The differences consist then not only in shape and size, but also in the type and composition of the materials used. In particular, at least one part of the shorter reinforcing elements may consist of a different material than the long fibers. Thus, for example, carbon fibers may be used for the long fibers, while glass fibers are used as the short fibers, or glass particles are used, for example, in the area of a thread. At least one part of the shorter reinforcing elements preferably comprises glass fiber material.

In particularly preferred embodiments, the spoke and/or the spoke nipple are designed materially integrally. It is particularly preferred that no specific material boundary surfaces are located in the volume of the spoke body, as such occur, for example, during gluing or also during welding of two separate workpieces.

The cross-sectional area (long fiber area) preferably has, in at least one end portion, a cross section deviating from a rotationally symmetrical cross section. It is thus preferred that an encasing of the long fibers in the cross-sectional area has a cross section deviating from a rotationally symmetrical cross section. An “encasing” is thereby understood as an “envelope” or a (virtual) shape. An “envelope” surrounds the cross-sectional area, which contains the reinforcing elements or long fibers. The three-dimensional shape of the cross-sectional area is defined overall by the location of the reinforcing elements or long fibers. The “envelope” surrounds the reinforcing elements as closely as possible. The envelope illustrates only the structure; it is not, however, an actual layer.

In all refinements and embodiments, it is preferred that the deviating cross section has a shape, which is taken from a group of shapes, comprising (roughly) a polygon, star-shape, oval, ellipse, or cone, or T-shaped or L-shaped or H-shaped, wherein the corners may be rounded. Using such configurations, the transmission of a higher torque is reliably guaranteed, which occurs, where appropriate, during fastening or calibrating the spoke.

An overall surface of the cross-sectional area remains particularly preferably identical, wherein the form changes at the transition to the deviating cross section.

For this purpose, the center piece is heated (at least) at its ends and, in preferred embodiments, at least one end is reshaped. The end of the center piece is then reshaped from an aerodynamic cross section into a round, angular, star-shaped or also oval cross section or the like, in order to facilitate a stronger holding of the spoke.

The long fibers contained in the cross-sectional area are thereby also pressed or moved into the new, deviating, cross-sectional shape. The end piece is then integrally formed around this (where appropriate, complex) geometric shape.

An encasing of the long fibers in the center piece may thereby have a first shape. In simple cases, a round cross-sectional shape. In other preferred cases, e.g., an aerodynamic and, e.g., approximately oval cross-sectional shape, which forms the cross-sectional area in the center piece.

In the finished end piece, an encasing of the long fibers (of the cross-sectional area with a deviating cross section) may have a second shape, which significantly deviates from the first shape. E.g., the second shape at the end piece may have, in cross section, a largest longitudinal extension, which is aligned transversely or perpendicular to a largest longitudinal extension in a cross section at the center piece.

A cross-sectional surface of the encasing remains, in particular, (virtually) identical in both cross sections. The volume of the cross-sectional area is reshaped at the end piece. Stated differently, a cross-sectional surface of the long fibers in the end piece remains the same size as in the center piece; however, the shape of an encasing or the outer shape of the cross-sectional area changes in the end piece.

If, e.g., an oval or round surface of the cross-sectional area is present in the center piece, and this is reshaped at the end piece and aligned ovally and transversely thereto, the axial load capacity of the spoke increases.

A cross-sectional profile, retaining the same cross-sectional surface from the center piece into the end piece, may change from a horizontal ellipse to a vertical ellipse, by which means the tensile strength of the spoke body is improved.

In general, during the assembly of the spoke systems in a wheel, the spokes are set under tension in such a way that, in regular operation, a significant tensile stress is always present within the spoke at every load that occurs.

In one embodiment, the cross-sectional portion is preferably accommodated centrally in the end piece and has a cone-like portion. It is then possible that long fibers surround the cone-like portion in the end piece.

The cross-sectional portion preferably radially surrounds the cross-sectional area (long fiber area) and the cross-sectional portion forms a thickening at the end piece.

It is particularly preferred that the threaded portion is designed at the cross-sectional portion (with shorter reinforcing elements).

It is particularly preferred that the long fibers extend through a central area of the center piece and through at least one central area of an end piece. The end piece with the threaded portion may comprise a central area, through which the long fibers extend, and an annular area, in which the thread is shaped and in which shorter reinforcing elements (or, where appropriate, no reinforcing elements at all) are introduced.

Preferably, a matrix material used in the cross-sectional area is, in particular, reversibly reshapable by thermal action. It is particularly preferred that a reversibly reshapable matrix material is included in the spoke body as a whole.

In all embodiments, it is particularly preferred that a thermoplastic matrix material is included in the cross-sectional area. It is particularly preferred that a thermoplastic matrix material is included in the spoke body as a whole. It is particularly preferred that at least (only) one thermoplastic matrix material is used in the spoke body.

A further wheel component according to the invention for a vehicle, and in particular for bicycles, comprises a connecting element of a spoke system, designed as a spoke and loaded in tension during operation. The spoke extends in the axial direction and comprises a center piece and two end pieces in order to detachably connect the spoke to a hub and to a rim by means of the end pieces. The spoke is manufactured from a fiber composite material and comprises at least one matrix material and reinforcing elements embedded therein. At least one end piece of the spoke has a thread in order to connect the spoke to a thread of another connecting element. The thread of the spoke is designed as non-symmetrical in the axial direction, so that one respective thread flank is designed as significantly shallower than the other, steeper thread flank. The end pieces are designed integrally with the center piece and respectively form an end of the spoke. At least some of the reinforcing elements are designed as long fibers and extend in a cross-sectional area completely through the center piece and respectively across at least a substantial part of both end pieces.

The applicant reserves the right to claim a wheel component for a vehicle, and in particular for bicycles, wherein the wheel component comprises a connecting element of a spoke system designed as a spoke nipple. The spoke system is provided for the purpose of detachably connecting a hub to a rim. The spoke nipple has a thread in order to connect or in order to be able to connect the spoke nipple to a spoke. The thread of the connecting element is designed as non-symmetrical in the axial direction, so that one respective thread flank is designed as significantly shallower than the other, steeper thread flank. The spoke nipple is thereby manufactured from a fiber composite material and comprises at least one matrix material and reinforcing elements embedded therein.

It is preferred that at least some of the reinforcing elements are designed as long fibers. The long fibers preferably extend substantially completely (“continuously”) through a nipple body of the spoke nipple. For example, covers or cover layers may thereby be applied on the ends of the nipple body. The fibers (long fibers) are then no longer visible at the ends.

A further wheel component according to the invention of a vehicle, and particular a bicycle, is provided in particular for a two-wheeler or multi-wheeler, that is at least partially muscle-powered in the intended normal or regular operation, and comprises a rim and a hub and multiple spoke systems, wherein a spoke system comprises (at least) two interacting connecting elements, namely a connecting element, (loaded in tension during operation and) designed as a spoke, and at least one connecting element designed as a spoke nipple, wherein the spoke extends in the axial direction and, in particular, is designed separately and straight. At least one spoke comprises a center piece and two end pieces, located opposite and spaced apart from one another. Using the end pieces, the hub is detachably connected to the rim via the spokes and at least one spoke nipple. The spoke nipple and at least one end piece of the spoke have interacting threads in order to connect the spoke and the spoke nipple to one another, wherein one of the threads is designed as an inner thread and one of the threads is designed as an outer thread. The interacting threads of the connecting elements are respectively designed as non-symmetrical in the axial direction, so that one respective thread flank is designed as significantly shallower than the other steeper thread flank. The spoke or the spoke body is manufactured from at least one fiber composite material and comprises at least one matrix material and reinforcing elements embedded therein. The end pieces are designed integrally with the center piece and respectively form an end of the spoke. At least some of the reinforcing elements are designed as long fibers (long reinforcing fibers) and extend completely through the center piece and respectively across at least a substantial part of both end pieces.

This wheel component according to the invention also has many advantages.

The spoke nipples may consist or be manufactured from a fiber composite material or also consist or be manufactured partially or also completely from a metal. A spoke nipple is preferably also manufactured from at least one fiber composite material and comprises, in particular, at least one matrix material and reinforcing elements embedded therein. In the case of the spoke, the end pieces are designed, in particular, integrally with the center piece and respectively form an end of the spoke.

The center piece of the spoke is preferably shaped according to a specific area of use. In preferred embodiments, the center piece of the spoke is aerodynamically shaped. This enables a low air resistance at low weight. The end piece in the spoke is accommodated at least virtually completely or completely within the rim. This enables a particularly advantageous configuration, in which the aerodynamic center piece extends up to the rim. A transition area is then not necessary. Because the greatest speeds relative to the surroundings occur particularly in the radially outermost area of the spoke at the rim, an aerodynamic configuration there is particularly advantageous. This is enabled by the invention.

Preferably, at least one spoke nipple made from a fiber composite material is used and screwed to the spoke. It is particularly preferred that all spokes and all spoke nipples are manufactured from fiber composite material.

It is particularly preferred that the material of the rim and also the material of the housing of the hub comprises fiber composite material and/or metal.

Additional advantages arise from the exemplary embodiments, which are subsequently explained in greater detail with reference to the appended figures.

### As Shown in the FIGURES:

FIG. 1 a schematic depiction of a racing bike;

FIG. 2 a schematic depiction of a mountain bike;

FIGS. 3a-3d schematic depictions of connecting elements of spoke systems according to the application;

FIG. 4 a schematic sectional view of a spoke of a spoke system according to the application;

FIGS. 5a-5c schematic depictions of connecting elements of spoke systems according to the application;

FIGS. 6a-10 schematic depictions of spokes of spoke systems according to the application;

FIGS. 11a-c schematic depictions of spoke nipples of spoke systems according to the application; and

FIG. 12 a schematic view of a spoke nipple.

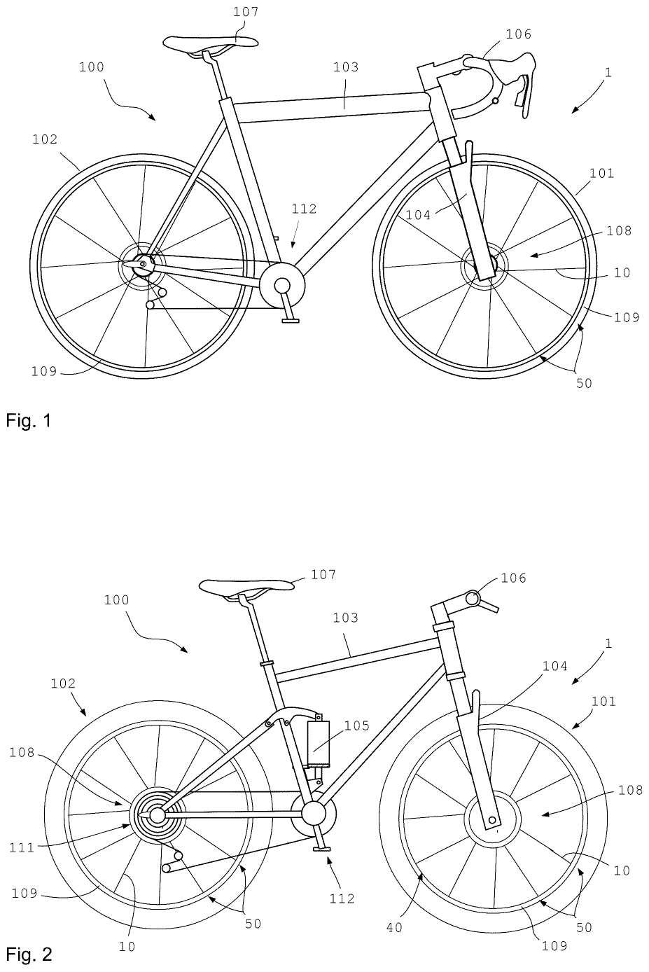

A mountain bike or a gravel bike and a racing bike 100 are respectively shown in FIGS. 1 and 2, which are respectively equipped with wheel components 1 according to the invention having spoke systems 40. The mountain bike or the racing bike 100 respectively has a front wheel 101 and a rear wheel 102.

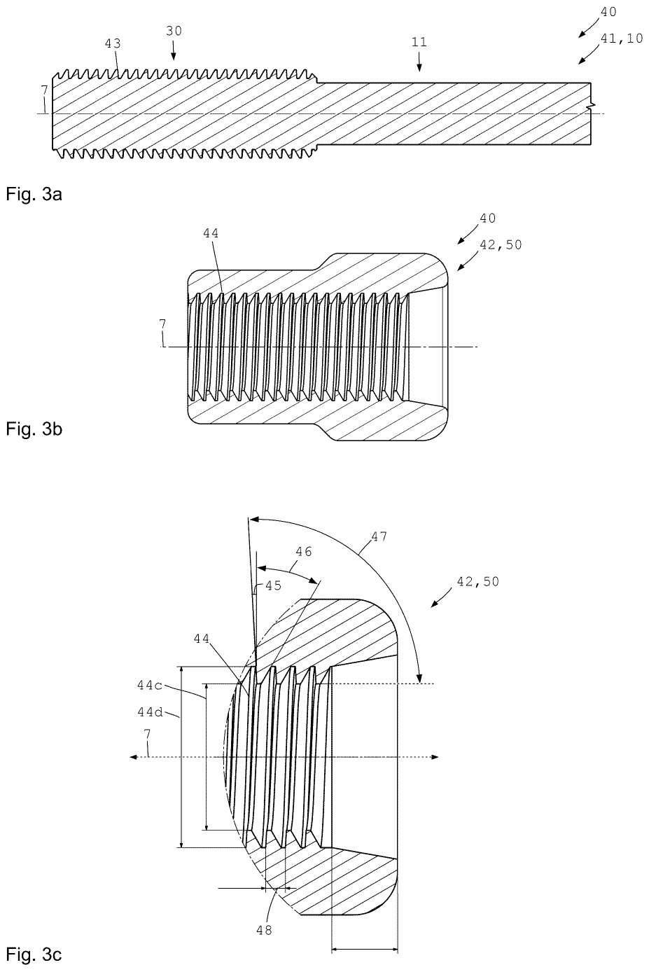

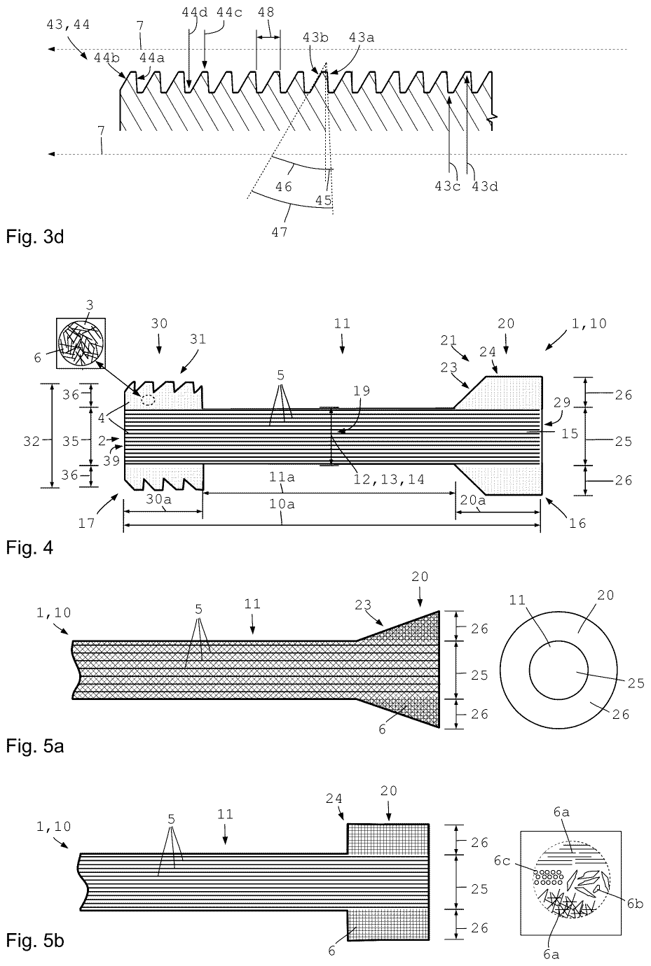

The two wheels 101, 102 have spokes 10 as connecting elements 41, which interact with spoke nipples 50 as connecting elements 42 (see FIGS. 3a-3b). A sprocket device 111 is provided. In principle, conventional rim brakes or also other brakes, like disc brakes, for example, may be provided.

The bicycles 100 respectively have a frame 103, handlebars 106, a seat 107, a fork or suspension fork 104, and, in the case of the mountain bike or a racing bike or gravel bike, a rear wheel suspension 105 may be provided. A pedal crank 112 with pedals functions as the drive. Where appropriate, an electric auxiliary drive may be provided at the pedal crank 112 and/or at the wheels. The hub of the wheels may respectively be fastened to the frame via a tensioning device like a through axle or quick release, for example.

Wheel component 1 according to the application having spokes 10 and spoke nipples 50 is visible in FIGS. 1 and 2. The spokes connect the hub 108 to the rim 109. In this case, the spoke nipples 50 are accommodated in the interior of the double wall rim 109, so that they are not visible in the side view.

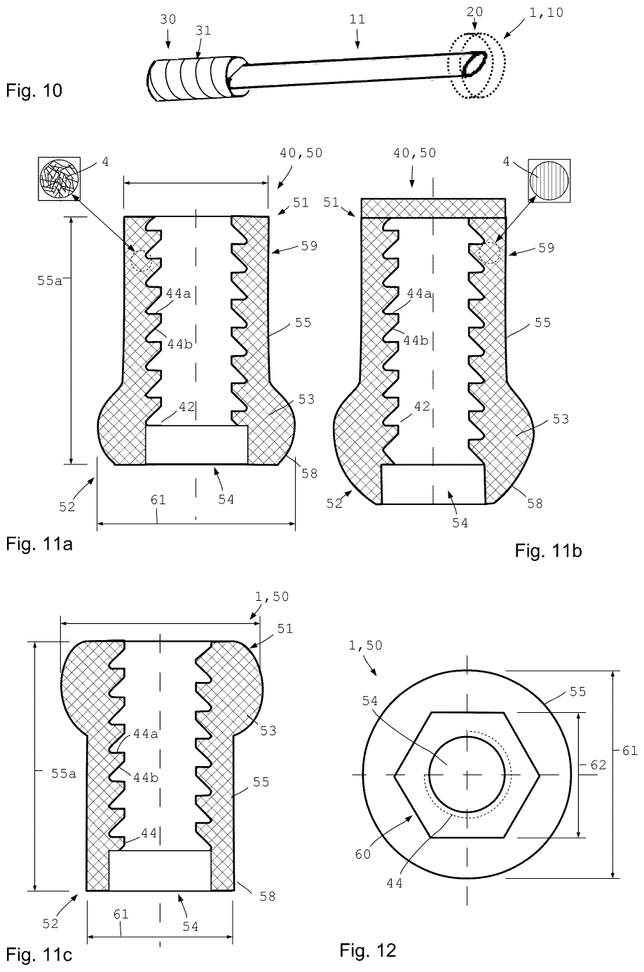

Different wheel components 1 according to the application are depicted in FIGS. 3a to 13. A wheel component 1 has spoke systems 40 with spokes 10 and spoke nipples 50.

A top view of a spoke 10 of a spoke system 40 is depicted in FIG. 3a. The spoke 10 has a center piece 11 and extends straight in the axial direction 7. The end piece 30, visible in this case, has an outer thread 43. The end portion has, in this case, a larger outer diameter than the center piece 11.

FIG. 3b shows a schematic cross section through a spoke nipple 50 as a connecting element 42 of the spoke system 40 in cross section, wherein the thread 44 is visible on the inside, and also the thickened end area, with which the spoke nipple 50 is supported in the interior of a rim. In this case, the nipple is supported with the thickened end area on the right end.

FIG. 3c shows the enlarged detail “E” from FIG. 3b. It is clear that the spoke nipple 50 has an inner thread 44, asymmetrical in the axial direction 7, due to which the thread flanks are designed as non-symmetrical to a transverse direction perpendicular to the axial direction 7. The thread flank 44a is significantly shallower and is aligned at an angle of 0° (±10°) to the transverse direction. The thread flank 44b is significantly steeper and is aligned at an angle of approximately 30° (±5°) to the transverse direction. The thread 44 has a thread pitch of approximately 0.45 mm (±0.2 mm) and has a clear inner diameter in this case of approximately 3.3 mm (±0.2 mm). The maximum diameter of the thread in this case is 4.13 mm (±0.2 mm). The outer diameter of the spoke nipple 50 is between 6 mm and 9 mm.

FIG. 3d shows a schematic depiction of the thread, enlarged yet again. In principle, the depiction applies both for an outer thread 43 and also for an inner thread, as both interact with one another and therefore must be adapted to one another.

The lower, marked center line 7 may apply for an outer thread 43. The thread then projects upward, and a shallower thread flank 43a and a steeper thread flank 43b result. The thread flank 43a is aligned almost perpendicular to the axial direction 7 and may dissipate high forces. The thread is configured as self-locking. The angle 45 is much smaller (shallower) than the angle 46. The angle 47 is composed in this case from the angles 45 and 46. The outer thread 43 has a minimum (outer) diameter 43c and a maximum (outer) diameter 43d.

The thread pitch 48 is identical for interacting outer thread 43 and inner thread 44.

FIG. 3d also schematically shows an inner thread of a spoke nipple. The upper, marked line 7 then depicts the axis of symmetry. The (non-hatched) thread then projects inwardly and thread flanks 44a (shallower) and 44b (steeper) result. The thread in this case may also dissipate high axial forces. The inner thread 44 has a minimum (inner) diameter 44c and a maximum (inner) diameter 44d.

FIG. 4 depicts a cross section through a spoke 10, which has an elongated center piece 11 and two end pieces 20, 30. The spoke 10 is integrally developed as a whole, and the spoke body 15 has no separating surfaces between the end pieces 20, 30 and the center piece 11.

The spoke 10 consists in this case of a fiber composite material 2 and comprises a matrix material 3 and reinforcing elements 4. Long fibers 5 thereby extend (at least virtually) completely across the length 10a of the spoke 10, centrally through the end piece 30, the center piece 11, and the end piece 20 at the other end of the spoke 10. The long fibers 5 may be covered at the very end, so that they are then not visible from outside.

Reference is made to the fact that the wheel component 1 or the connecting elements 41, 42 are not depicted to scale in FIGS. 4-12, in order to be able to more clearly show the individual parts and components of the spoke system 40. In reality, the spoke 10 from FIG. 4 has a length 10a of, for example, 290 mm or 300 mm and may, if it is not aerodynamically designed, have a diameter between 1 mm and 3 mm or 4 mm, for example. Other dimensions are also possible. These dimensions are also provided here in order to clarify that the images are not depicted to scale.

It is clear in FIG. 4 that the end piece 30 has a threaded portion 31, which is designed as an outer thread 43 and extends in this case across the complete width or length 30a of the end piece 30. The thread is configured analogously to that seen in FIG. 3d. The other end piece 20 has a thickened portion 23, which contacts the center piece 11 and extends up to the end of the spoke across a support or cylindrical section 24, which connects to the thickened portion 23.

In simple embodiments, the center piece 11 is designed as round, at least in the central area 19, so that the minimum transverse dimension 12, the average transverse dimension 13, and the maximum transverse dimension 14 respectively have the same value, and correspond in this case to the diameter of the center piece 11. In other embodiments, the spoke 11 may be designed, e.g., aerodynamically, so that the minimum, average, and maximum transverse dimension 12-14 respectively differ from one another.

The long fibers 5 extend as reinforcing elements 4 across the complete length 10a of the spoke 10. The long fibers 5 in the end pieces 20, 30 are thereby respectively located only in the (central) cross-sectional area 25 at the end piece 20 and the cross-sectional area 35 at the end piece 30.

At the end pieces 30, the cross-sectional portion 35, which likewise consists of a fiber composite material 2 and in this case also has the same matrix material 3 as the center piece 11, connects radially outwardly to the cross-sectional area 36.

Unlike the center piece 11 and the cross-sectional areas 25, 35, shorter reinforcing elements 6 are used, which in this case may consist of short fibers 6a or fiber snippets 6b and/or reinforcing particles 6c, in the cross-sectional portions 26, 36.

In simple embodiments, a matrix material 3 (together with short fibers 6a) is injection molded at the ends 16, 17, wherein the matrix material 23 is at least initially first remelted there, if it had previously solidified (somewhat). As a result of this production, no separate boundary surfaces or adhesive surfaces or surfaces arise within the matrix material 3 between the cross-sectional portion 36 and the cross-sectional area 35. A transition between the cross-sectional area 35 and the cross-sectional portion 36 is only able to be realized by the change of the embedded reinforcing material. This leads to a particularly high load capacity of the wheel component 1 according to the application.

In the exemplary embodiment according to FIG. 4, the long fibers 5 are located in the central areas 29, 39 of the end pieces.

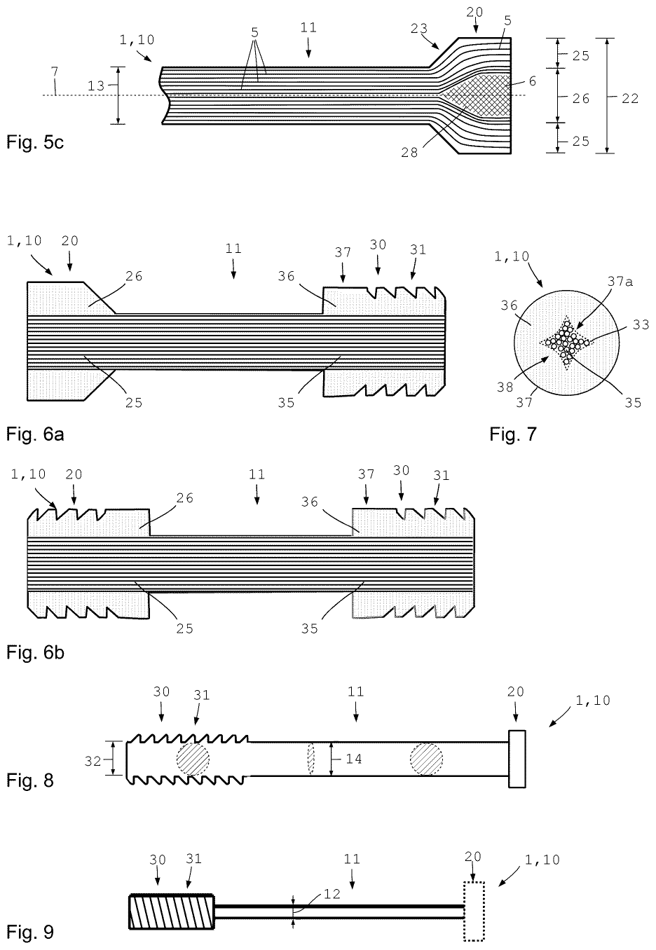

Variants of a wheel component 1 according to the application having a spoke system 40 and a spoke 10 are depicted in FIGS. 5a-5c, wherein in each case only the end piece 20 and a part of the center piece 11 of the spoke 10 is respectively depicted.

Unlike FIG. 4, the end piece 20 in FIG. 5a is designed overall as conical. The cross-sectional area 25 is also penetrated by long fibers 5 in this case, while the cross-sectional portion 26 connects radially outwardly using the same matrix material 3 but shorter reinforcing elements 6. The end piece 20 also forms the head portion 21 of the spoke 10 in this case and functions for supporting the spoke at the rim or at the hub.

As the schematic sketch on the right side of FIG. 5a shows, both the center piece 11 and also the end piece 20 are designed as rotationally symmetrical in the exemplary embodiment according to FIG. 5a. It is also possible in this case that the center piece 11 is aerodynamically designed, so that the cross-sectional shape deviates from the circular shape.

FIG. 5b shows a further variant of a spoke 10 of a spoke system 40 of a wheel component 1, in which the end piece 20 has no thickened portion 23, but instead has only a support or cylindrical portion 24 projecting at right angles in this case.

On the right side of FIG. 5b, some different reinforcing elements 6a, 6b, 6c are illustrated by way of example, which may be used in the cross-sectional portion 26 at the end piece 20 (and in the cross-sectional portion 36 of the other end piece 30).

Both chaotically-arranged shorter reinforcing elements 6a and also short forms of reinforcing elements 6a aligned in the same direction may be used, as well as fiber snippets 6b in the same or different orientation, and also reinforcing particles 6c. A combination of different reinforcing elements 6a, 6b, 6c is also possible. It is also possible that few or even no reinforcing elements are contained in a cross-sectional portion 26, 36.

FIG. 5b shows only an end piece 20. The other end piece 30 may be designed identically. Or both end pieces 20, 30 respectively (also) have a threaded portion 31 of a thread 43. The shape of one or both end pieces may be designed as previously depicted. A wheel may comprise different spokes.

FIG. 5c shows a variant of a wheel component having a spoke 10, wherein in this case, following the pultrusion, the end 16 is melted at the end piece 20 and a cone-like element is inserted, wherein, after the removal, the cavity creates a cone-like portion 28, which is filled with a fiber composite material 2 and a matrix material 3 and reinforcing elements 4. In this case, the cross-sectional portion 26 having shorter reinforcing elements 6 is provided in the center, while the long fibers 5 in the cross-sectional area 25 then extend annularly around the cross-sectional portion 26. As a whole, the end piece is expanded to a diameter 22.

FIG. 6a shows a further variant, wherein the end piece 30 in this case is designed as longer, or wherein in this case the threaded portion 31 of the thread 43 does not extend across the entire length of the end piece 30. It connects to an end portion 37, which is designed as cylindrical in this case. The end piece 30 has an asymmetrical outer thread 43, in which the thread flanks 43a, 43b are aligned as differently steep.

In FIG. 6a as well, the long fibers 5 are provided across the complete length of spoke 10 and extend practically completely across the length of the end pieces 20, 30 and the center piece 11.

FIG. 6b shows a variant of a spoke 10 with two end pieces 20, 30, which both have a respective outer thread and, in this case, are designed as mirror symmetrical with respect to the center piece 11 in order to respectively optimally dissipate the tensile forces that occur.

The cross-sectional area 25 comprises (only) long fibers as reinforcing fibers and extends from one end of the spoke to the other end. This means that the long fibers extend completely through the spoke from one end piece through the center piece and the other end piece.

In all embodiments, the cross-sectional areas 25, 35 at the end pieces 20, 30 are delimited (and, in this case, surrounded) by cross-sectional portions 26, 36, in which (only) short fibers and (at least virtually) no long fibers are contained. That is indicated here by the different hatchings. The center piece 11 is produced materially integrally with the end pieces 20, 30. In particular, the end pieces 20, 30 have the identical matrix material as the center piece.

A cross section in the end portion 37 from FIG. 6 is depicted in FIG. 7. It is clear in this case that the reinforcing elements 4, arranged within a circle in the center piece 11, take on another cross-sectional shape in the end piece 30 (and, where appropriate, also in the end piece 20). Namely, the cross-sectional shape is configured as non-circular, so that a deviating cross section 37a results, which in this case is similar to a square that has indentations on the side faces. The envelope 33, indicated by dashed lines, surrounds the reinforcing elements 4 as closely as possible, and is only indicated to illustrate the shape. In reality, the envelope does not exist. It is not a separate layer. The spoke body is manufactured materially integrally. The cross-sectional shape may also be designated as star-shaped. The transfer of a higher torque is thereby enabled, which is advantageous when setting the spoke tension. The deviating cross section 37a may be configured along the spoke as cone-shaped portion 38, or may have an increasing transverse dimension in the direction of the end.

Other deviating cross-sectional shapes for the cross-sectional area or the long fiber area 35 are also possible; thus, its cross-sectional shape may be also be designed as triangular or oval or T-shaped or V shaped or W-shaped or the like.

Another wheel component having a spoke system 40 with a spoke 10 is depicted in FIGS. 8-10, wherein FIGS. 8 and 9 show two side views, wherein it is clear that the spoke 10 is aerodynamically designed so that the minimum transverse dimension 12 in the center piece 11 is significantly smaller than the maximum transverse dimension 14.

At the ends 16, 17, the spoke 10 is respectively designed as round again at the end pieces 20, 30 and has a threaded portion 31 on the end piece 30. The outer diameter 32 on the end piece 30 may correspond to the maximum transverse dimension 14 in the center piece 11.

A wheel component 1 according to the application having a spoke nipple 50 of a spoke system 40 is depicted in FIGS. 11a, 11b, and 11c. FIGS. 11a and 11b thereby show two slightly different exemplary embodiments, respectively in cross section.

The spoke nipple 50 consists in this case of a fiber composite material 2 and comprises a matrix material 3 and reinforcing elements 4. The reinforcing elements 4 may be designed as long fibers 5 or as shorter reinforcing elements 6.

The spoke nipple 50 has a nipple body 55, which extends across a length 55a, which may be, for example, 10 mm. Somewhat shorter and also somewhat longer embodiments are also possible. The nipple body 55 has a length 55a larger than a diameter 61 of the nipple body.

The nipple body has end portions 51 and 52 on the ends 58 and 59. At the end 58 in FIG. 11a and FIG. 11b, the nipple head 53 is designed, which is designed as rounded, and the contact surface is provided, on which the nipple is supported, for example, on the rim.

A receptacle 54 (insertion aid) for the threaded end of a spoke is designed on the nipple head 53. An inner thread 44 is designed in the receptacle. The nipple head 53 may be screwed onto a spoke end via the thread 44. The receptacle 54 may be designed as a through opening. It is also possible that the other end 51 is partially or completely closed. The receptacle 54 is then a blind hole.

FIG. 11c shows another embodiment of a spoke nipple 50, in which the thread 44 is oriented in the opposite direction. In this case, the spoke nipple does not contact the rim with the end portion 52, but instead with the conical or rounded outer side of the nipple head 53, which faces the end 52.

FIG. 12 shows a top view of the end portion 51 of the spoke nipple 50. The tool contact 60 with the width across flats 62 is thus visible on the nipple body 55. The receptacle 54 is visible in the center, in which the thread 44 is designed.

The spoke system 40 may reliably transfer high forces and is designed as self-locking. A gluing of the spoke and the spoke nipple is therefore not necessary. The absence of adhesive improves and simplifies maintenance options.

By using spoke nipples 50 made from fiber composite material, a lighter spoke nipple may be provided, which in turn also reliably prevents a potential contact corrosion of different metals with one another. In particular, if reinforcing elements with a glass fiber content are used, then problems of this type are reliably reduced or entirely prevented.

In all embodiments, a material connection and materially-integral connection is achieved.

During the production of spoke nipples 50, for example, 20, 30, 40 or more cavities may be simultaneously filled in a production mold, so that, following the production of one tool, a cost-efficient production is possible.

The threads for the wheel components are provided directly in the fiber composite material.

### LIST OF REFERENCE NUMERALS

1 Wheel component
2 Fiber composite material
3 Matrix material
4 Reinforcing elements
5 Long fibers
6 Shorter reinforcing elements
6a Short fibers
6b Fiber snippets
6c Reinforcing particles
7 Longitudinal axis, axial direction
10 Spoke
10a Length of 10
11 Center piece
11a Length of 11
12 Transverse dimension (minimum)
13 Transverse dimension (average)
14 Transverse dimension (maximum)
15 Spoke body
16 End
17 End
19 Central area
20 End piece
20a Length of 20
21 Head portion
22 Outer diameter
23 Thickened portion
24 Support portion, cylindrical section
25 Cross-sectional area
26 Cross-sectional portion
28 Cone-like portion
29 Central area
30 End piece
30a Length of 30
31 Threaded portion, outer thread
32 Outer diameter
33 Envelope
35 Cross-sectional area, long fiber area
36 Cross-sectional portion, short fiber portion
37 End portion
37a Deviating cross section
38 Cone-like portion
39 Central area
40 Spoke system
41 Connecting element, spoke unit
42 Connecting element, spoke unit
43 Thread, outer thread
43a Thread flank (shallower)
43b Thread flank (steeper)
43c Minimum diameter
43d Maximum diameter
44 Thread, inner thread
44a Thread flank (shallower)
44b Thread flank (steeper)
44c Minimum diameter
44d Maximum diameter
45 Angle (shallower)
46 Angle (steeper)
47 Flank angle
48 Thread pitch of 43, 44
50 Spoke nipple
51 End portion
52 End portion
53 Nipple head
54 Receptacle
55 Nipple body
55a Length
58 End (rounded)
59 End (tool end)
60 Tool contact
61 Diameter
62 Width across flats
100 Bicycle
101 Wheel, front wheel
102 Wheel, rear wheel
103 Frame
104 Fork, suspension fork
105 Rear wheel suspension
106 Handlebars
107 Seat
108 Hub
109 Rim
111 Sprocket device
112 Pedal crank

1. A wheel component for bicycles, comprising: a spoke system having at least two interacting connecting elements, namely having a connecting element loaded in tension during operation designed as a spoke and having at least one connecting element designed as a spoke nipple;
wherein the spoke extends in the axial direction and comprises a center piece and two end pieces in order to detachably connect the spoke to a hub and to a rim by means of the end pieces;
wherein the spoke is manufactured from a fiber composite material and comprises at least one matrix material and reinforcing elements embedded therein;
wherein the spoke nipple and at least one end piece of the spoke have interacting threads in order to connect the spoke and the spoke nipple to one another, wherein one of the threads is designed as an inner thread and one of the threads is designed as an outer thread; and
wherein the interacting threads of the connecting elements are respectively designed as non-symmetrical in the axial direction, so that one respective thread flank is designed as significantly shallower than the other, steeper thread flank;
the end pieces are designed integrally with the center piece and respectively form an end of the spoke, and at least some of the reinforcing elements are designed as long fibers and extend in a cross-sectional area completely through the center piece and respectively across at least a substantial part of both end pieces.

2. The wheel component according to claim 1,
wherein at least one end piece comprises at least one cross-sectional portion with shorter reinforcing elements embedded therein;
and wherein a significant part of the cross-sectional area has exclusively long fibers, and wherein a significant part of the cross-sectional portion has exclusively shorter reinforcing elements.

3. The wheel component according to claim 1, wherein at least one of the end pieces comprises a threaded portion for screwing to a spoke nipple.

4. The wheel component according to claim 1, wherein at least one of the end pieces has a head portion for supporting the spoke.

5. The wheel component according to claim 1,
wherein the shallower thread flank is respectively aligned in the tensile direction in the assembled state and forms a load-bearing flank, and wherein the shallower thread flank has an angle of less than 10° perpendicular to the longitudinal direction;
and wherein the steeper thread flank has an angle greater than 20° perpendicular to the longitudinal direction, and forms a non-load-bearing flank, and wherein the steeper thread flank has an angle less than 60° perpendicular to the longitudinal direction.

6. The wheel component according to claim 1,
wherein a flank angle between the thread flanks is between 25° and 60°;
and wherein a maximum thread diameter of an outer thread is less than 5 mm;
and wherein a minimum thread diameter of an inner thread is greater than 2 mm;
and wherein a thread pitch is between 0.3 mm and 0.9 mm.

7. The wheel component according to claim 1, wherein the spoke nipple consists at least partially of a metal.

8. The wheel component according to claim 1, wherein the matrix material of at least one connecting element is uniform overall.

9. The wheel component according to claim 1, wherein the cross-sectional area has, in at least one end portion, a cross section deviating from a rotationally symmetrical cross section, and wherein the deviating cross section has a shape, which is taken from a group of shapes, comprising a polygon, star-shape, oval, ellipse, or enveloping cone shape.

10. The wheel component according to claim 1, wherein the cross-sectional portion is accommodated centrally in the end piece and has a cone-like portion.

11. The wheel component according to claim 1, wherein the cross-sectional portion radially surrounds the cross-sectional area, and wherein the cross-sectional portion forms a thickening at the end piece.

12. The wheel component according to claim 1, wherein the threaded portion is designed on the cross-sectional portion.

13. The wheel component according to claim 1, wherein the long fibers extend through a central area of the center piece and through at least one central area of an end piece.

14. The wheel component according to claim 1, wherein at least one connecting element comprises a thermoplastic matrix material.

15. A wheel component for bicycles, comprising: a connecting element of a spoke system, loaded in tension during operation and designed as a spoke;
wherein the spoke extends in the axial direction and comprises a center piece and two end pieces in order to detachably connect the spoke to a hub and to a rim by means of the end pieces;
wherein the spoke is manufactured from a fiber composite material and comprises at least one matrix material and reinforcing elements embedded therein;
wherein at least one end piece of the spoke has a thread in order to connect the spoke to a thread of another connecting element;
wherein the thread of the spoke is designed as non-symmetrical in the axial direction, so that one respective thread flank is designed as significantly shallower than the other, steeper thread flank;
the end pieces are designed integrally with the center piece and respectively form an end of the spoke, and at least some of the reinforcing elements are designed as long fibers and extend in a cross-sectional area completely through the center piece and respectively across at least a substantial part of both end pieces.

16. A wheel component for a bicycle, having a rim and a hub and having multiple spoke systems, wherein a spoke system comprises two interacting connecting elements, namely a connecting element loaded in tension during operation and designed as a spoke;
and at least one connecting element designed as a spoke nipple;
wherein the spoke extends in the axial direction;
and comprises a center piece and two end pieces located opposite and spaced apart from one another, in order to detachably connect the hub to the rim by means of the spoke and at least one spoke nipple and to support at the end pieces;
wherein the spoke is manufactured from at least one fiber composite material and comprises at least one matrix material and reinforcing elements embedded therein;
wherein the spoke nipple and at least one end piece of the spoke have interacting threads in order to connect the spoke and the spoke nipple to one another, wherein one of the threads is designed as an inner thread and one of the threads is designed as an outer thread;
wherein the interacting threads of the connecting elements are respectively designed as non-symmetrical in the axial direction, so that one respective thread flank is designed as significantly shallower than the other, steeper thread flank;
the end pieces are designed integrally with the center piece and respectively form an end of the spoke;
and that at least some of the reinforcing elements are designed as long fibers and extend in a cross-sectional area completely through the center piece and respectively across at least a substantial part of both end pieces.

17. The wheel component according to claim 16, wherein the center piece is aerodynamically shaped, and wherein the end piece of the spoke is accommodated at least virtually completely within the rim.

18. The wheel component according to claim 16, wherein an inner thread which is screwed to an outer thread of the spoke is designed on the hub.
